(19) United States
(12) Patent Application Publication
(10) Pub. No.: US 2011/0090805 A1
(43) Pub. Date: Apr. 21, 2011

(54) SYSTEMS AND METHODS PROVIDING A DECOUPLED QUALITY OF SERVICE ARCHITECTURE FOR COMMUNICATIONS

(75) Inventor: Jiancong Chen, Shenahen (CN)

(73) Assignee: Hong Kong Applied Science and Technology Research Institute Co., Ltd., Shatin (CN)

(21) Appl. No.: 12/603,166

(22) Filed: Oct. 21, 2009

(51) Int. Cl. H04L 12/26; H04W 72/04

(52) U.S. Cl. 370/252; 370/329

(57) ABSTRACT

Systems and methods which provide a decoupled quality of service (QoS) architecture for communications are shown. Embodiments implement a QoS technique which separates a packet scheduling function and a data packet mapping function in providing communications meeting desired QoS parameters. Accordingly, embodiments provide a QoS architecture in which a packet scheduler is used to determine data packet transmission priorities and in which a data mapper is used to allocate transmission frame space to data packets, wherein the packet scheduling and data mapping algorithms are decoupled or independent. A protocol data unit (PDU) pool is utilized to buffer data packets between the decoupled packet scheduler and data mapper of embodiments to facilitate their combined operation to provide desired QoS delivery.

### TECHNICAL FIELD

The invention relates generally to communications and, more particularly, to providing a decoupled quality of service architecture for communications.

### BACKGROUND OF THE INVENTION

The use of various communications infrastructure, whether wireline, wireless, optical, etc., has seen substantial growth in recent years, to the point of seemingly ubiquitous deployment. For example, wireless telephony infrastructure, such as advanced mobile phone systems (AMPS), personal communications service (PCS) systems, global system for mobile (GSM) systems, etc., has been widely deployed and utilized to provide wireless voice communications for a number of years. Wireless data communication infrastructure, such as provided by wireless local area networking (WLAN) systems (e.g., WiFi access points operable in accordance with the IEEE 802.11 protocol standards), wireless metropolitan area networking (WMAN) systems (e.g., WiMAX base station operable in accordance with the IEEE 802.16 protocol standards), and wireless telephony systems (e.g., second generation (2G) and third generation (3G) wireless networks), has more recently been deployed and utilized to provide wireless data communications. A number of different terminal device configurations may be provided wireless communications using the foregoing infrastructure. For example, cellular telephones, personal digital assistants (PDAs), personal computers (PCs), Internet appliances, multimedia devices, etc. may utilize each utilize one or more of the foregoing wireless communication infrastructure for communication of information such as voice, images, video, data, etc.

Different communication sessions, devices, applications, etc. may have different communication demands associated therewith. For example, voice and video communications are typically intolerant of latency and jitter. That is, sound and streaming image reproduction anomalies associated with substantial delays in transmission of portions of the information or with information arriving with appreciably different amounts of delay are generally readily detectable in the quality of the reproduced voice and streaming images. Likewise, data communications are often appreciably slowed due to dropped packets and their attendant requests for retransmission. Accordingly, various parameters may affect the perceived quality of service depending upon the particular communication session being conducted, the particular type of device used, the particular application, etc.

The concept of “quality of service” has been developed to facilitate delivery of desired levels of communications services via network infrastructure. Quality of service (QoS), as generally implemented with respect to communication infrastructure, is the ability to provide different priority to different applications, users, or communication sessions (e.g., data flows or streams), or to guarantee a certain level of performance to a communication session. For example, bit rate, delay, jitter, packet dropping probability, and/or bit error rate may be guaranteed at a predetermined threshold for a particular level of quality of service. Such quality of service guarantees can become important with respect to a application, user, or communication session if the network capacity is insufficient to accommodate all the demand placed upon the network. For example, the user experience for real-time streaming multimedia applications, such as voice over Internet protocol (VoIP), online gaming, and Internet protocol television (IP-TV) may suffer intolerably when network demand exceeds capacity, and QoS techniques are not implemented with respect to these communication session, since these communication sessions often require fixed bit rate and are delay sensitive.

Accordingly, various network communication standards accommodated the implementation of QoS techniques. A network protocol that supports QoS may specify minimum and/or maximum traffic parameters for particular applications, users, communication sessions, etc., and reserve or otherwise make available capacity in the network nodes for their network communication traffic. For example, such QoS traffic parameters may be established during a session establishment phase. During the communication session a network controller may monitor the achieved level of performance, for example the data rate and delay, and dynamically control scheduling priorities in the network nodes to achieve the agreed upon QoS.

Such QoS techniques, although perhaps easily understood in concept, are typically quite complicated to implement. Many network communication standards, although specifying some level of QoS, often do not actually specify the particular QoS technique to be implemented. For example, the IEEE 802.16 wireless communication standard, often referred to as WiMAX, specifies that QoS techniques are to be provided but does not specify any particular algorithm or technique to implement such QoS. Accordingly, equipment manufacturers (e.g., WiMAX base station manufacturers) and/or communication service providers (e.g., network operators) are left to develop and implement a suitable QoS technique.

The present inventors have discovered that various undesired characteristics are often associated with traditional approaches for implementing QoS techniques, such as incompatibility with expected or desired communications equipment, unfair bandwidth distribution among users, impractical demands upon resources available to implement the algorithms, etc. For example, a traditional approach for providing a QoS technique has been the multiuser diversity approach, wherein resources are allocated to the user with better channel quality. However, such a QoS technique penalizes the users with poorer channel quality and thus generally does not ensure fair bandwidth distribution among users. Another traditional approach for providing a QoS technique has been the utility maximization approach, wherein a usage rate adaptation scheme such as using the formula of equation (1) below is used.

$${max}_{Q ∈ Θ} {\sum }_{i = 1}^{N} E ( {U}_{i} ( {T}_{i} ) ) \\ subject to P \{ Q ( U ) = i \} \geq {T}_{i} , i = 1 , 2 , … , N \\ {r}_{i} = {\sum }_{k ∈ {D}_{i}} c \frac{P}{i} [ k ] Δ f . \qquad ( 1 )$$

In the foregoing, cᵢ^{P}[k]=ƒ(log₂(1+βp[k]pᵢ[k])), where ƒ(•) depends on the used rate adaptation scheme, and β is a constant related to a targeted bit-error rate

$$( BER ) by β = \frac{1.5}{- ln ( 5 BER )} .$$

Such schemes, however, are very complex and usually impractical to implement. For example, even if sufficient processing resources are available to solve the foregoing equations, accurate parameters for solving the equations are often not available from the network.

### BRIEF SUMMARY OF THE INVENTION

The present invention is directed to systems and methods which provide a decoupled QoS architecture for communications. Embodiments of the invention implement a QoS technique which separates a packet scheduling function and a data packet mapping function in providing communications meeting desired QoS parameters. Accordingly, embodiments of the invention provide a QoS architecture in which a packet scheduler is used to determine data packet transmission priorities and in which a data mapper is used to allocate transmission frame space to data packets (also referred to as bursts or requests (e.g., requests for transmission of data)), wherein the packet scheduling and data mapping algorithms are decoupled or independent. A protocol data unit (PDU) pool is utilized to buffer data packets between the packet scheduler and data mapper of embodiments to facilitate their combined operation to provide desired QoS delivery.

Decoupled QoS architectures implemented according to embodiments of the invention provide practical and efficient scheduling to meet desired QoS metrics. The decoupled data mapping of embodiments operates to provide efficient burst allocation within transmission frames, such as the orthogonal frequency division multiple access (OFDMA) frames of a wireless communication system operating in accordance with the WiMAX standards. By implementing a decoupled QoS architecture according to embodiments of the invention, an independent algorithm for scheduling may be utilized which achieves desired QoS metrics while an independent algorithm for data mapping achieves desired radio resource efficiency.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a system configured according to embodiments of the invention;

FIG. 2 shows a flow diagram of operation of the system of FIG. 1 to provide decoupled quality of service for communications according to embodiments of the invention;

FIG. 3 shows detail with respect to the protocol data unit pool of FIG. 1 according to embodiments of the invention;

FIG. 4 shows detail with respect to the data packet mapping function of FIG. 2 according to embodiments of the invention; and

FIGS. 5A and 5B show graphs of the mapping efficiency and mapping cost of embodiments of the invention.

### DETAILED DESCRIPTION OF THE INVENTION

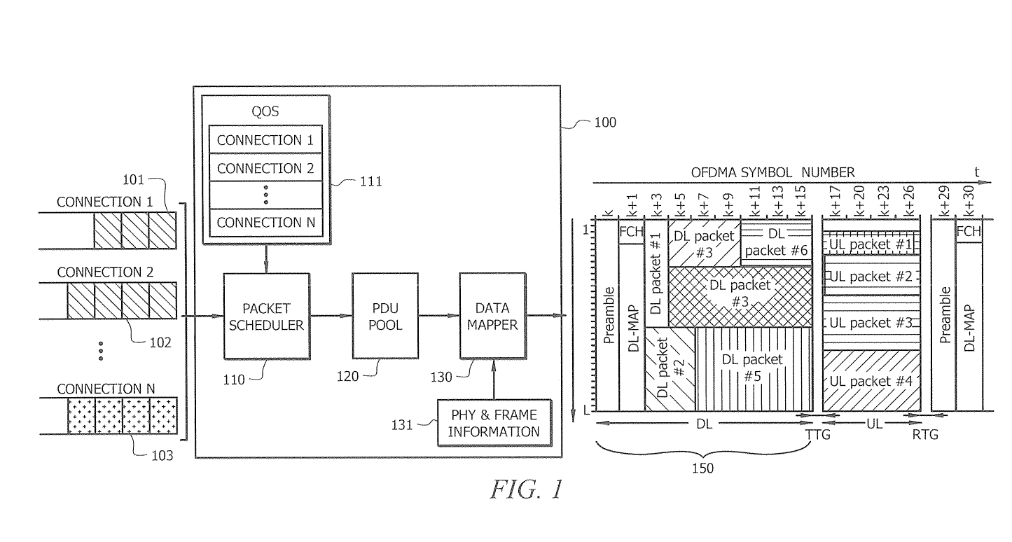

FIG. 1 shows a system configured according to an embodiment of the invention. Specifically, system 100 is shown having a decoupled QoS architecture for communications, such as via links of one or more networks (e.g., local area networks (LANs), metropolitan area networks (MANs), wide area networks (WANs), intranets, extranets, the Internet, the public switched telephone network (PSTN), cellular networks, cable transmission systems, and/or the like). System 100 may comprise various configurations of communication apparatus, such as an access point, base station, router, multiplexer, switch, gateway, concentrator, network hub, network interface, etc. For example, system 100 of embodiments of the invention comprises a base station operable in accordance with the IEEE 802.16 protocol standards (i.e., a WiMAX base station). In such an embodiment, data flows 101-103 may comprise active communication sessions associated with one or more network node in communication with system 100 and frame 150 may comprise an orthogonal frequency division multiple access (OFDMA) frame transmitted as part of one or more WiMAX communication links (e.g., WiMAX communications associated with one or more network node in wireless communication with system 100).

The illustrated embodiment of system 100 includes packet scheduler 110 operable to determine data packet transmission priorities as described in detail below. Packet scheduler 110 of embodiments of the invention comprises processing circuitry operable under control of logic defining operation to determine data packet transmission priorities as described herein. For example, packet scheduler 110 may comprise a general purpose processing unit (e.g., a PENTIUM processor available from Intel Corporation) operable under control of software and/or firmware to provide operation as described herein. Additionally or alternatively, packet scheduler 110 may comprise special purpose processing circuitry (e.g., application specific integrated circuits (ASICs), programmable gate arrays (PGAs), etc.) configured to provide operation as described herein.

QoS database 111 is provided for use by packet scheduler 110 in the illustrated embodiment. QoS database 111 of embodiments comprises information regarding different priorities and/or performance levels to be given to different applications, users, communication sessions (e.g., data flows or streams), and/or communications links. For example, QoS database 111 may comprise information regarding guaranteed, minimum, maximum, and/or threshold bit rates, delay, jitter, packet dropping probabilities, and/or bit error rates for a particular level of quality of service as may be provided to applications, users, communication sessions, and/or communication links through operation of system 100. System 100 may support multiple quality of service levels. Such information may be utilized by packet scheduler 110 to determine data packet transmission priorities to provide desired QoS delivery. For example, where system 100 operates according to WiMAX standards one or more of a plurality of classes of traffic, such as unsolicited grant service (UGS), extended real-time polling service (ertPS), real-time polling service (rtPS), non-real-time polling service (nrtPS), and best-efforts (BE), may be accommodated.

Protocol data unit (PDU) pool 120 is included in the illustrated embodiment of system 100. PDU pool 120 of embodiments is operable to buffer data packets prioritized by packet scheduler 110. PDU pool 120 may comprise various forms of memory, such as random access memory (RAM), magnetic memory, optical memory, etc., configured to provide data packet buffering as described herein.

The illustrated embodiment of system 100 includes data mapper 130 operable to allocate transmission frame space to data packets. Data mapper 130 of embodiments of the invention comprises processing circuitry operable under control of logic defining operation to allocate transmission frame space to data packets as described herein. For example, data mapper 130 may comprise a general purpose processing unit (e.g., a PENTIUM processor available from Intel Corporation) operable under control of software and/or firmware to provide operation as described herein. Additionally or alternatively, data mapper 130 may comprise special purpose processing circuitry (e.g., application specific integrated circuits (ASICs), programmable gate arrays (PGAs), etc.) configured to provide operation as described herein.

It should be appreciated that, although illustrated separately and although providing decoupled QoS operation, packet scheduler 110 and data mapper 130 may share processing circuitry. For example, a same general purpose processing unit may operate under control of software providing functionality of packet scheduler 110 and software providing functionality of data mapper 130 according to embodiments of the invention.

Physical layer (PHY) information and frame database 131 is provided for use by data mapper 130 in the illustrated embodiment. PHY and frame database 131 of embodiments comprises information regarding communication system physical layer (e.g., the characteristics of the communications interface) and the rules for sending and receiving information across the physical communication connection (e.g., the frame layout, payload formatting, data packet requirements and limitations, etc.). For example, PHY and frame database 131 may comprise information regarding mapping of data into a frame payload portion, minimum and/or maximum data sizes, etc. Such information may be utilized by data mapper 130 to map data packets, as prioritized by packet scheduler 110, into frames of a communication protocol used by a network communication link to provide desired QoS delivery.

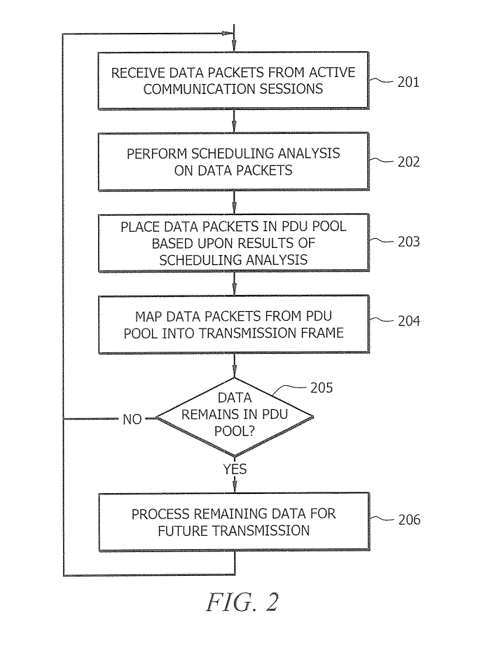

FIG. 2 shows a flow diagram of operation of system 100 to provide decoupled QoS for communications according to an embodiment of the invention. At block 201 of the illustrated flow diagram, data packets are received from active communication sessions. For example, data flows 101-103 (FIG. 1) may be provided by the active communication sessions and thus received at one or more inputs of system 100. The data packets of these active communication sessions may be received into an input buffer or other queue (not shown) for storage prior to further processing by system 100. It should be appreciated that the data packets so received may include data packets for which different qualities of service are to be provided. For example, the data packets associated with particular applications, users, communication sessions, and/or communications links may have different priorities and/or performance levels associated therewith.

At block 202 of the illustrated embodiment scheduling analysis of the data packets is performed by packet scheduler 110 (FIG. 1). Embodiments of the invention operate to implement a scheduling algorithm or algorithms in order identify a scheduling hierarchy of the data packets. The aforementioned algorithms may utilize information from QoS database 111 (e.g., information regarding guaranteed, minimum, maximum, and/or threshold bit rates, delay, jitter, packet dropping probabilities, bit error rates, etc. to be provided to applications, users, communication sessions, communication links, etc.) in combination with information regarding the received data packets (e.g., information, such as header information, port information, data type information, source identification, destination identification, address information, payload content, etc., associating data packets with particular applications, users, communication sessions, etc.) to prioritize data packet transmission scheduling or otherwise determine a scheduling hierarchy.

For example, embodiments of the invention implement a double round robin scheduling algorithm to provide scheduling analysis with respect to the data packets. One such round robin scheduling algorithm implements a minimum bandwidth guaranteed scheduling algorithm as the first round of the double round robin scheduling algorithm and a delayed preferred scheduling algorithm as the second round of the double round robin scheduling algorithm. The first round, minimum reserved traffic rate scheduled for transmission using a double round robin scheduling algorithm of embodiments may be determined using the following formula:

Dataₘᵢₙ(i,n)=Rate_{(i,min)}T_{interval,i}−Σ_{k=n-T+1}ⁿ⁻¹Dataₛₑₙₜ(i,k) (2)

wherein i represents the particular connection or data flow and n represents the particular frame, and wherein Dataₘᵢₙ represents the minimum data payload occupied by guaranteed data packet traffic, Rate represents QoS requirement data throughput rate, Tᵢₙₜₑᵣᵥₐₗ and T represents number of the frames for statistic, and Dataₛₑₙₜ represents the data payload sent in the previous (T−1) frames. The second round, maximum traffic scheduled for transmission using a double round robin scheduling algorithm of embodiments may be determined using the following formula:

Dataₘₐₓ(i,n)=Rate_{(i,max)}T_{interval,i}−Σ_{k=n-T+1}ⁿ⁻¹Dataₛₑₙₜ(i,k) (3)

wherein Dataₘₐₓ represents the maximum data payload occupied by non-guaranteed data packet traffic. If a connection is scheduled in both rounds, embodiments send the data according to Dataₘₐₓ(i,n) only.

A minimum bandwidth guaranteed scheduling algorithm of embodiments operates to identify data packets associated with QoS requirements providing a minimum bandwidth requirement for which data packet transmission in the next transmission frame is needed to meet those QoS requirements. For example, a minimum bandwidth guaranteed scheduling algorithm may operate to identify data packets of UGS and ertPS QoS categories and data packets of an rtPS QOS category which are approaching a QoS deadline as data packets for which transmission in the next transmission frame is needed. Accordingly, these data packets are identified as being associated with a higher level in the data packet scheduling hierarchy according to embodiments of the invention.

The delayed preferred scheduling algorithm of embodiments operates to identify data packets having delay requirements (e.g., the data packet is approaching a delay limit, the data packet has been queued for a threshold amount of time, the data packet has been queued a longest time compared to other data packets, etc.) to be met in an upcoming (e.g., next) transmission frame. For example, a delayed preferred scheduling algorithm may operate to identify data packets of an rtPS QoS category which are not approaching a QoS deadline and nrtPS and BE QoS categories as data packets for transmission in an upcoming frame. Accordingly, these data packets are identified as being associated with a lower level in the data packet scheduling hierarchy.

It should be appreciated that some of the received data packets may not be selected by a scheduling algorithm for transmission in a next or upcoming transmission frame by scheduling algorithms implemented according to embodiments of the invention. For example, particular data packets may neither meet a minimum bandwidth guaranteed criteria nor a delayed preferred criteria. Such data packets may be held in an input queue for later scheduling analysis (e.g., as such data packets become further delayed or conditions otherwise change they may meet one or more scheduling criteria). Such data packets may additionally or alternatively be identified in a lowest level in the data packet scheduling hierarchy, such as to be placed in the non-guaranteed queue when space is available.

At block 203 of the illustrated embodiment the data packets are placed in PDU pool 120 by packet scheduler 110 (both shown in FIG. 1) based upon the scheduling analysis performed in block 202. Embodiments of PDU pool 120 provide a plurality of data packet queues to buffer data packets prioritized by packet scheduler 110 in accordance with the data packet scheduling hierarchy. For example, PDU pool 120 may comprise a plurality of data packet queues, each associated with different data packet scheduling hierarchies.

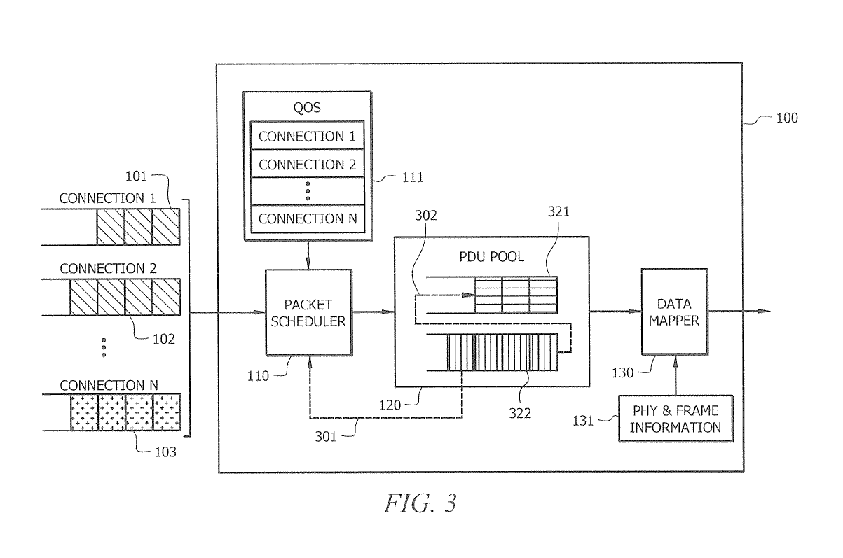

Directing attention to FIG. 3, an embodiment wherein PDU pool 120 includes guaranteed queue 321 and non-guaranteed queue 322 is shown. Guaranteed queue 321 of the illustrated embodiment is used to queue data packets that are to be guaranteed inclusion in a next transmission frame, such as may comprise the data packets meeting the minimum bandwidth guaranteed scheduling algorithm discussed above. Non-guaranteed queue 322 of the illustrated embodiment is used to queue data packets that are to be included in an upcoming transmission frame (e.g., a next possible transmission frame), such as may comprise the data packets meeting the delayed preferred scheduling algorithm discussed above. Thus, according to embodiments of the invention, data packets placed in guaranteed queue 321 by packet scheduler 110 will be placed in a next transmission frame while data packets placed in non-guaranteed queue 322 will be placed in a next transmission frame if sufficient frame payload space remains. The foregoing utilization of guaranteed queue 321 and non-guaranteed queue 322 operates to meet QoS parameters as well as to provide long-term fairness among the connections or data flows.

Referring again to FIG. 2, at block 204 of the illustrated embodiment data mapper 130 maps data packets from PDU pool 120 into a next transmission frame. Data mapper 130 of embodiments obtains data packets first from guaranteed queue 321 (FIG. 3) to form or fill frame 150 (FIG. 1) and thereafter, having emptied guaranteed queue 321 and space within the payload section of frame 150 permitting, obtains data packets from non-guaranteed queue 322 (FIG. 3) to fill frame 150. That is, after having placed all received data packets associated with guaranteed bandwidth data flows in the next transmission frame, the quality of service bandwidth needs have been met and thus the residual bandwidth in the frame is used to carry additional traffic, which in the above described embodiment is prioritized as data packets having the then most stringent delivery needs associated therewith. It should be appreciated that, where guaranteed queue 321 includes no data packets (e.g., no guaranteed bandwidth data flows are active), data mapper 130 may form and fill frame 150 using data packets from non-guaranteed queue 321. It should further be appreciated that many network protocols implement admission control techniques such that network capacity, or guaranteed bandwidth, is not exceeded. The use of such admission control, for example, may function to ensure that guaranteed bandwidth data packets, such as those queued in guaranteed queue 321, do not exceed transmission frame payload capacity.

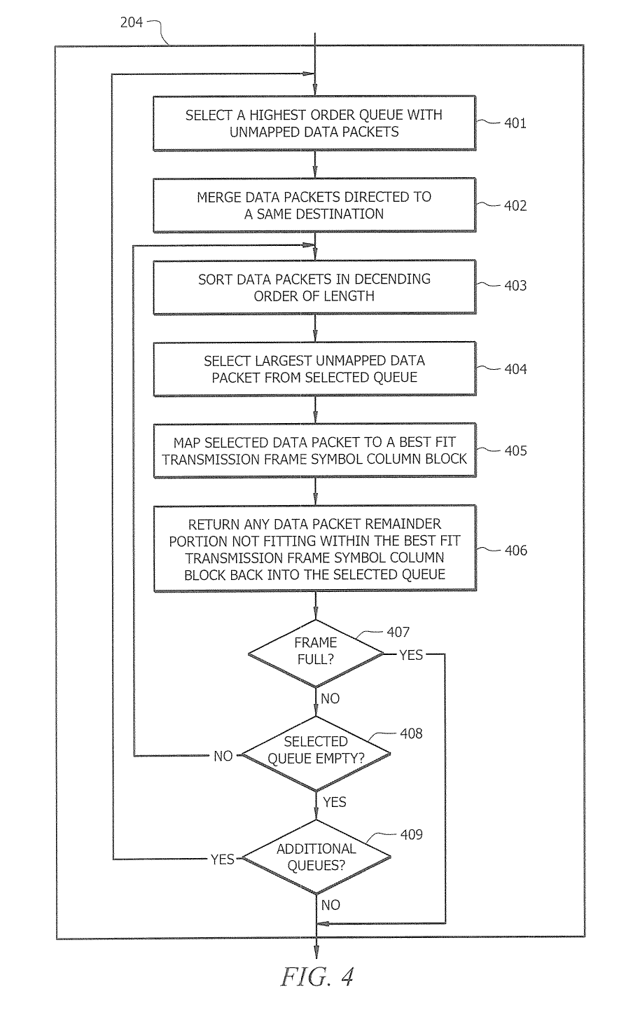

Directing attention to FIG. 4, a flow diagram showing detail with respect to data packet mapping provided by data mapper 130 at block 204 of FIG. 2 according to embodiments is shown. Data packet mapping according to embodiments of the invention operates to map data according to the aforementioned scheduling analysis. For example, where such scheduling analysis results in multiple data packet queues in PDU pool 120, such as guaranteed queue 321 and non-guaranteed queue 322, data packet mapping may be performed for each such queue in hierarchical order. Accordingly, the illustrated embodiment selects a highest order or priority queue (e.g., guaranteed queue 321 first and non-guaranteed queue 322 in a subsequent iteration) having unmapped data packets for performing the following functionality with respect to in a current iteration at block 401.

Block 402 of the illustrated embodiment operates to merge the data packets of the selected queue, such as for efficient mapping into the transmission frame payload portion. For example, transmission frames may provide a multi-dimensional architecture in which data packets are to be laid out for forming the frame. Accordingly, various data packets to be included in the frame may be merged where they are associated with delivery to a same destination, for example, to thereby provide a larger contiguous data block to facilitate data packet mapping.

It should be appreciated that merged data packets present a data unit larger than an originally received data packet. Accordingly, the data packets referred to herein after having been processed to provide the aforementioned merging of data packets may include both merged data packets and data packets which remain unaltered by the foregoing processing.

At block 403 of the illustrated embodiment, the merged data packets of the selected queue are sorted by size, such as to facilitate best fit placement within the frame. For example, the data packets may be sorted in descending order of length. At block 404 of the illustrated embodiment a largest unmapped data packet is selected from the currently selected queue for mapping into the transmission frame payload portion.

At least a portion of the selected data packet is mapped to the transmission frame at block 405 of the illustrated embodiment. Continuing with the foregoing example wherein system 100 comprises a WiMAX base station configuration, frame 150 of the illustrated embodiment comprises a two dimensional architecture, wherein one dimension comprises a symbol dimension (symbol columns kᵢ) and one dimension comprises the sub-channel dimension (subcarriers s). Such protocols may provide for mapping data packets into the frame in rectangular shapes (kᵢ columns by s subcarriers), as may be determined using PHY and frame database 131. Mapping of data packets according to embodiments of the invention operates so as to fill a largest number of available (unused) columns according to embodiments. For example, the symbol length of a selected data packet, Rᵢ, may be represented as:

Rᵢ=kᵢs+rᵢ (4)

wherein kᵢ is a largest run length of available transmission frame columns, s is the number of subcarriers for which the kᵢ columns are available (e.g., the number of adjacent subcarriers from which a rectangle of kᵢ columns may be formed in the transmission frame payload portion), and rᵢ is any data packet remainder portion not included in the kᵢs symbols.

Embodiments operate to map the selected data packet into a rectangle (kᵢs) of available symbol positions within the transmission frame payload portion (block 405) and return the remainder portion, rᵢ to the selected queue (block 406). If there are not enough subcarrier slots available in the column of kᵢ width to map kᵢs symbols of the selected data packet, the remaining portion of the selected data packet may be combined with the remainder portion, rᵢ, and returned to the selected queue.

It should be appreciated that the aforementioned data packet remainders present a data unit smaller than an originally received data packet. Accordingly, the data packets referred to herein after having been mapped and resulting in a remainder may include both remainder data packets and data packets which remain unaltered by the foregoing processing.

At block 407 of the illustrated embodiment a determination is made as to whether the transmission frame payload portion is full. If the transmission frame payload portion is full, no more data packet mapping is performed according to the illustrated embodiment and processing exits the data packet mapping block (block 204 of FIG. 2). However, if the transmission frame payload portion is not full, processing according to the illustrated embodiment proceeds to block 408.

At block 408 of the illustrated embodiment a determination is made as to whether the selected queue is empty (i.e., whether data packets remain in the selected queue for mapping into the transmission frame payload portion). If the selected queue is not empty, processing according to the illustrated embodiment returns to block 403 for sorting of the data packets and selection of a next data packet from the selected queue for mapping (block 404). It should be appreciated that, in this manner, all data packets for the selected queue, including any remainder data packet portions returned to the selected queue, are mapped into the transmission frame payload portion where space permits. If, however, the selected queue is empty, processing according to the illustrated embodiment proceeds to block 409.

At block 409 of the illustrated embodiment a determination is made as to whether there are additional queues of the PDU pool which have not had their data packets mapped to the transmission frame payload portion. If there are additional queues for which data packet mapping is to be provided, processing according to the illustrated embodiment returns to block 401 for selection of a next queue for data packet mapping. However, if there are no additional queues for which data packet mapping is to be provided, no more data packet mapping is performed according to the illustrated embodiment and processing exits the data packet mapping block (block 204 of FIG. 2).

It should be appreciated that the embodiment illustrated in FIG. 4 provides a best fit technique for mapping data packets into the transmission frame payload portion. Moreover, iterative mapping of the hierarchical queues as shown in FIG. 4 facilitates meeting QoS parameters with respect to different data packets. Alternative techniques for mapping data packets into frames may be utilized according to embodiments of the invention, if desired.

Referring again to FIG. 2, having mapped data packets into the transmission frame payload portion at block 204, processing according to the illustrated embodiment proceeds to block 205. At block 205 of the illustrated embodiment a determination is made as to whether any data packets remain unmapped in the PDU pool. For example, a determination may have been made at block 407 (FIG. 4) that the frame was full prior to all the data packets held in PDU pool 120 were mapped to frame 150. If no data packets in the PDU pool remain unmapped, processing according to the illustrated embodiment returns to block 201 to provide processing for subsequent transmission frames. However, if data packets in the PDU pool remain unmapped, processing according to the illustrated embodiment proceeds to block 206.

At block 206 of the illustrated embodiment the data packets PDU pool which remain unmapped are processed for inclusion in a subsequent transmission frame. For example, the unmapped data packets may be returned to packet scheduler 110 (line 301 of FIG. 3) for scheduling analysis with subsequently received data packets. Such scheduling analysis may result, for example, in these formerly unmapped data packets receiving heightened status (e.g., being placed in guaranteed queue 321) due to their delay times and/or other metrics. Alternatively, the unmapped data packets may be moved up in status (line 302 of FIG. 3) for data mapping in a subsequent transmission frame (e.g., moved to guaranteed queue 321). After processing the remaining data packets for inclusion in a subsequent transmission frame processing according to the illustrated embodiment returns to block 201 to provide processing for such subsequent transmission frames.

It should be appreciated that, although various functions have been described in order in the embodiments discussed above, functions described herein may be performed in different orders according to embodiments of the invention. For example, although FIG. 2 shows receiving data packets and performing scheduling analysis of data packets prior to placing data packets in a PDU pool and mapping data packets to a transmission frame, receiving data packets and/or performing scheduling analysis of data packets may be done in parallel with placing data packets in a PDU pool and/or mapping data packets to a transmission frame.

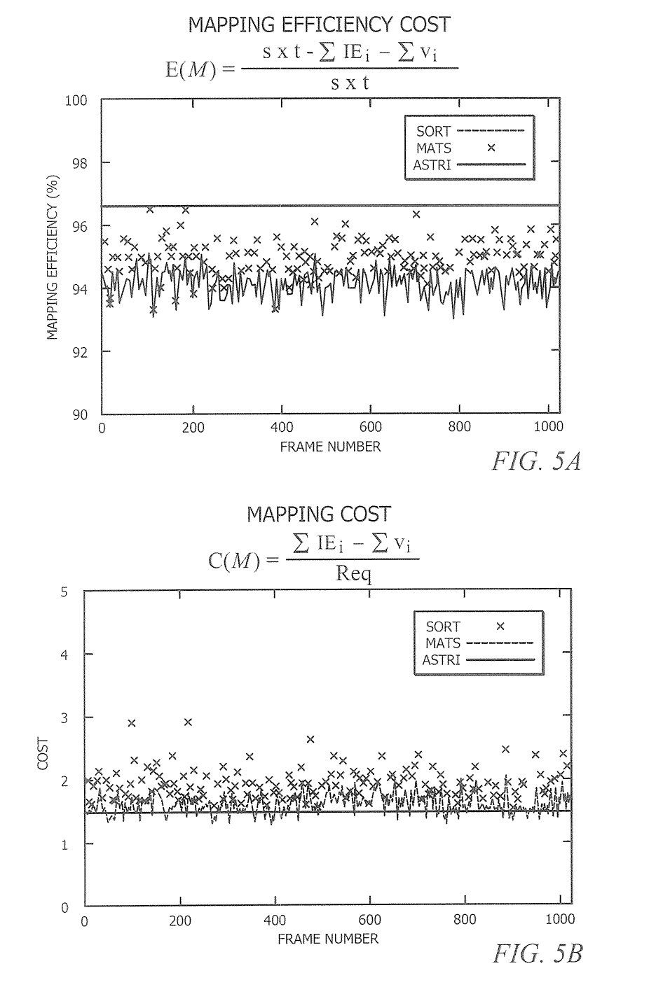

Decoupled QoS architectures for communications in which a QoS technique implements separate packet scheduling and data packet mapping as described with respect to the embodiments above provides efficient QoS communications. For example, the mapping efficiency (slots used for data over other slots) provided by above described embodiments results mapping efficiency of more than 96%, as show in the graph of FIG. 5A. Such a mapping efficiency is appreciably better than that of the 94-95% efficiency of other mapping techniques (e.g., the SORT technique shown in Y. Ben-Shimol et al., “Two-Dimensional Mapping for Wireless OFDMA System,” IEEE Transactions on Broadcasting, vol. 52, issue 3, September 2006 pp. 388-396 and the MATS technique shown in X. Jin et al., “An Efficient Downlink Data Mapping Algorithm for IEEE 802.16e OFDMA Systems,” IEEE GlobeCom 2008, Nov. 30, 2880-Dec. 4, 2008, the disclosures of which are hereby incorporated herein by reference). The mapping cost (number of IEs and the number of empty slots over the number of requests in the request queue) provided by above described embodiments results in mapping cost of approximately 1.5, as shown in the graph of FIG. 5B. Such a mapping cost is as good as or better than other mapping techniques (e.g., better than the SORT technique shown in Y. Ben-Shimol et al. and as good as the MATS technique shown in X. Jin et al.).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
performing scheduling analysis for data packets to be communicated, the scheduling analysis using quality of service parameters for determining a scheduling hierarchy of the data packets;
placing the data packets in a pool as a function of results of the scheduling analysis; and
mapping the data packets in the pool to a communication frame, wherein the mapping implements quality of service communication in accordance with the quality of service parameters.

2. The method of claim 1, wherein the scheduling analysis identifies a plurality of data packet statuses.

3. The method of claim 1, wherein the scheduling analysis identifies data packets associated with guaranteed bandwidth data flows.

4. The method of claim 3, wherein the scheduling analysis identifies data packets having most stringent delivery needs associated therewith.

5. The method of claim 1, wherein the performing scheduling analysis for data packets utilizes information from a quality of service database.

6. The method of claim 1, wherein the placing the data packets in a pool comprises:
placing first selected data packets in a first queue of the pool; and
placing second selected data packets in a second queue of the pool, wherein the first selected data packets and the second selected data packets are selected in accordance with the scheduling analysis.

7. The method of claim 6, wherein the first queue comprises a guaranteed queue from which data packets queued therein are guaranteed to be mapped to the communication frame by the mapping, and wherein the second queue comprises a non-guaranteed queue from which data packets queued therein are mapped to the communication frame by the mapping on a space available basis.

8. The method of claim 1, wherein the mapping the data packets comprises:
merging data packets of the data packets which are directed to a same destination;
sorting at least a portion of the data packets according to a length thereof;
selecting a largest unmapped data packet of the sorted data packets;
mapping the selected data packet to the communication frame; and
repeating the selecting and mapping.

9. The method of claim 8, wherein the at least a portion of the data packets comprise data packets assigned to a same queue of the pool.

10. The method of claim 8, wherein the mapping the selected data packet to the communication frame comprises:
providing a best fit to an available rectangular area of the communication frame payload portion.

11. The method of claim 10, wherein the providing a best fit uses a maximum available column run length for the mapping the selected data packet to the communication frame.

12. The method of claim 10, wherein the providing a best fit results in a remainder portion of the selected data packet being returned to the pool for subsequent mapping.

13. A method comprising:
providing a decoupled quality of service data packet handling architecture with respect to a network node, wherein the decoupled quality of service data packet handling architecture is configured to provide a packet scheduling function decoupled from a data packet mapping function;
receiving data packets to be communicated at the network node;
providing the packet scheduling function of the decoupled quality of service data packet handling architecture with respect to the data packets, wherein the packet scheduling function organizes the data packets in accordance with quality of service parameters; and
providing the data packet mapping function of the decoupled quality of service data packet handling architecture with respect to the data packets organized by the packet scheduling function, wherein the data packet mapping function maps at least a portion of the data packets into a communication frame to implement a desired level of quality of service.

14. The method of claim 13, further comprising:
placing the data packets in a pool in accordance with the organization of the data packets provided by the packet scheduling function.

15. The method of claim 14, wherein the placing the data packets in the pool comprises:
placing first selected data packets in a first queue of the pool; and
placing second selected data packets in a second queue of the pool.

16. The method of claim 15, wherein the first queue comprises a guaranteed queue from which data packets queued therein are guaranteed to be mapped to the communication frame by the data packet mapping function, and wherein the second queue comprises a non-guaranteed queue from which data packets queued therein are mapped to the communication frame by the data packet mapping function on a space available basis.

17. The method of claim 13, wherein the data packet mapping function comprises:
merging data packets of the data packets which are directed to a same destination;
sorting at least a portion of the data packets according to a length thereof;
selecting a largest unmapped data packet of the sorted data packets;
mapping the selected data packet to the communication frame; and
repeating the selecting and mapping.

18. The method of claim 13, wherein the data packet mapping function comprises:
providing a best fit mapping of data packets to an available rectangular area of the communication frame.

19. The method of claim 18, wherein the providing a best fit uses a maximum available column run length for the mapping the selected data packet to the communication frame.

20. The method of claim 18, wherein the providing a best fit results in a remainder portion of the selected data packet being returned to the pool for subsequent mapping.

21. A system comprising:
a network node having a decoupled quality of service data packet handling architecture, wherein the decoupled quality of service data packet handling architecture is adapted to provide a packet scheduling function decoupled from a data packet mapping function.

22. The system of claim 21, wherein the decoupled quality of service data packet handling architecture comprises:
a packet scheduler providing the packet scheduling function; and
a data mapper providing the data packet mapping function.

23. The system of claim 22, wherein the packet scheduler comprises logic circuitry providing the packet scheduling function, and wherein the data mapper comprises logic circuitry providing the data packet mapping function.

24. The system of claim 22, wherein the decoupled quality of service data packet handling architecture further comprises:
a data packet pool adapted to receive data packets from the data packet scheduler and to provide the data packets to the data mapper.

25. The system of claim 24, wherein the data packet pool comprises:
a plurality of data packet queues.

26. The system of claim 25, wherein the plurality of data packet queues comprise:
a guaranteed queue, wherein data packets in the guaranteed queue are guaranteed to be mapped to a next communication frame by the data mapper; and
a non-guaranteed queue, wherein data packets in the non-guaranteed queue are mapped to the next communication frame on a space available basis by the data mapper.

27. The system of claim 22, further comprising:
a quality of service database providing quality of service information to the packet scheduler to provide the packet scheduling function; and
a frame database providing frame information to the data mapper to provide the data packet mapping function.

28. The system of claim 21, wherein the network node comprises a base station.

29. The system of claim 28, wherein the base station provides wireless communications using the decoupled quality of service data packet handling architecture for orthogonal frequency division multiple access communications.
